(19) United States
(12) Patent Application Publication
(10) Pub. No.: US 2025/0061446 A1
(43) Pub. Date: Feb. 20, 2025

(54) METHOD AND SYSTEM FOR ESCROW-FREE ATOMIC CROSS-CHAIN SWAP WITH RECIPIENT'S CONFIRMATION

(71) Applicant: JINAN UNIVERSITY, Guangzhou (CN)

(72) Inventors: Yongdong WU, Guangzhou (CN); Tong LI, Guangzhou (CN); Shishi HUANG, Guangzhou (CN); Jiao LU, Guangzhou (CN); Jian WENG, Guangzhou (CN); Ming LI, Guangzhou (CN); Zhiquan LIU, Guangzhou (CN)

(73) Assignee: JINAN UNIVERSITY, Guangzhou (CN)

(21) Appl. No.: 18/537,839

(22) Filed: Dec. 13, 2023

(30) Foreign Application Priority Data
Aug. 16, 2023 (CN) 202311029127.1

(51) Int. Cl. G06Q 20/36

(52) U.S. Cl. CPC G06Q 20/3678

(57) ABSTRACT

A system for enabling escrow-free, secure, and convenient atomic asset swaps between blockchains are provided. In detail, when any group of users reach an agreement on the content of cross-chain asset swap transactions, each participant creates an individual signature on the content of each transaction, employs a reversible signature aggregate function to produce an aggregate signature from all his/her individual signatures, and optionally generates a proof to prove the relationship between the aggregated signature and the transaction contents. Sequentially, all the participants exchange these aggregated signatures and optional proofs. Once a participant publishes one of his/her individual signature, the other parties can use both signatures—one from the sender and the other from the recipient—to construct a complete transaction. Once a transaction is broadcast, its corresponding transactions are constructed, and broadcast. Upon all transactions being confirmed by the blockchain nodes or miners, the asset swap between participants is completed.

### CROSS REFERENCE TO THE RELATED APPLICATIONS

This application is based upon and claims priority to Chinese Patent Application No. 202311029127.1, filed on Aug. 16, 2023, the entire contents of which are incorporated herein by reference.

### TECHNICAL FIELD

This invention relates to the field of asset swap. Specifically, it allows users to securely and conveniently achieve escrow-free asset swap between blockchains.

### BACKGROUND

Blockchain is a distributed ledger technology that records and verifies transactions in a decentralized manner. Each blockchain network has its own rules and protocols. With the advancement of blockchain technology, the coexisting blockchains are no longer isolated islands, and their value derives from the exchange of assets or data between blockchains. In fact, cross-chain swapping is the fundamental and crucial aspect of achieving interoperability between blockchains. Cross-chain asset swaps face certain challenges that need to be addressed. Different blockchain systems employ varying consensus mechanisms and protocol rules, making cross-chain asset swaps difficult. Additionally, due to the distributed and decentralized nature of blockchain, there is inherent mutual distrust among participating parties. Cross-chain asset swaps also involve interactions between two or more chains, which can result in a significant amount of data being processed, limiting the potential for blockchain's development and application prospects.

Cross-chain asset swap refers to the process where a user Alice transfers her holdings of assets (α units) on blockchain A to a user Bob on blockchain B, and simultaneously, Bob transfers his holdings of assets (β units) to Alice. The atomicity of cross-chain swaps ensures the integrity of the transaction, meaning that the entire exchange process either successfully completes or fails completely, with no possibility of partial success.

The approach in cross-chain asset swaps that relies on a trusted third party (TTP) is commonly referred to as ‘intermediaries’ or ‘notaries.’ Their role involves facilitating and verifying the exchange of assets. Their responsibilities include verifying and recording transactions to ensure their validity and security. Intermediaries typically require a certain level of credibility and trustworthiness to gain users' confidence in relying on them to execute transactions. A trusted central notary can ensure the security and reliability of cross-chain asset swaps, enabling fast and convenient asset transfers while supporting compatibility between multiple blockchain networks. However, the notary system also poses some challenges, including potential single points of failure and trust issues, which may increase transaction costs and reduce efficiency.

U.S. Pat. No. 10,652,019 B1 employs zero-knowledge proofs to indicate the possession of an asset and commit the asset to the peer so as to perform transactions or atomic swaps. In the invention, a message service is employed to deliver data to help atomic swap system.

Smart contracts provide a trustless solution for cross-chain asset swaps, eliminating the need for reliance on the third-party. These contracts, executed on the blockchain, automate and enforce transaction rules, facilitating cross-chain asset swaps. The process involves primarily locking, validating, releasing, and refunding cross-chain assets. Hash Time-Locked Contracts (HTLCs) are commonly employed to manage the locking, releasing, and refunding phases. However, HTLCs require participating chains to support compatible hash functions and time-locking capabilities, which may result in limited operability and scalability, along with higher execution costs. Additionally, failure to adhere to the contract rules by participants could potentially lead to asset losses.

A multi-signature address refers to an address that requires multiple private key signatures to execute a transaction. Typically, it is composed of public keys from different participants. Only when a sufficient number of private keys sign a transaction can that transaction be accepted. In cross-chain asset swaps, multi-signature addresses are primarily used for locking and releasing assets to provide enhanced security. However, managing multiple private keys and ensuring an adequate number of signatures during the exchange process increases the complexity and the probability of errors.

These methods all require escrow of exchange funds, however, interoperability issues between different blockchains may result in funds being ‘locked’ and unable to operate effectively on other networks. Furthermore, asset escrow often involves time across multiple blockchain networks, potentially leading to delays or failures in the execution of exchanges. In asset exchanges, malicious attacks on smart contracts or TTP can result in fund loss. Given these challenges, the question of how to achieve decentralized, non-custodial, secure, reliable, and user-friendly cross-chain asset swaps is of paramount importance.

### US PATENTS

[1] U.S. Pat. No. 10,652,019 B1. A. R. F. Nicolas, R. Kahat. P. Kogan, Y. Gurkan, and O. Wallenstein. Atomic swap using zero-knowledge proofs, and applications thereof. May 12, 2020.

### OTHER PUBLICATIONS

[1] M. Herlihy, “Atomic cross-chain swaps,” ACM Symposium on Principles of Distributed Computing, pp. 245-254, 2018.
[2] S. Bowe and D. Hopwood, “BIP-199: Hashed time-locked contract transactions,” 2017.
[3] S. A. K. Thyagarajan and G. Malavolta, “Lockable signatures for blockchains: Scriptless scripts for all signatures,” IEEE Symposium on Security and Privacy, 937-954, 2021.
[4] G. Malavolta, P. Moreno-Sanchez, C. Schneidewind, A. Kate, and M. Maffei, “Anonymous multi-hop locks for blockchain scalability and interoperability,” The Network and Distributed System Security Symposium 2019.

### SUMMARY

Most atomic swap methods require the assets to be “locked or escrowed”, which can lead to risks of fund loss or theft, centralized risks, and inefficiencies in the speed and effectiveness of the exchange. To achieve atomic swaps of assets across different blockchains without the need for asset escrow, this paper discloses a secure and convenient cross-chain atomic swap system. First, all participants negotiate and determine specific transaction contents and sign to confirm each transaction content. Then, they use a reversible signature aggregate function to create a proof and share it with the other participants. Upon receiving the proof, the recipient verifies it. Once verified success, any participant can initiate the execution of the transaction by sending their transaction signature to the others.

In this system, assume that two users, User1 and User2, have completed their registration. User1 has α coins, stored in wallet W₁₁ on blockchain A; also, on blockchain B, User1 has a wallet W₁₂. User2 has β coins stored in wallet A on blockchain B; meanwhile, on blockchain A, User1 has a wallet W₂₂. Now, User1 intends to use her a coins on blockchain A to exchange with User2's β coins on blockchain B.

In accordance with the first aspect of the invention, a method is disclosed for securely and conveniently swapping assets between different blockchains using a multi-signature scheme without asset escrow. The method includes the following steps:
participants negotiate to determine the terms and conditions of two transactions;
participants use their private keys to individually sign the transaction content off-chain;
a reversible signature aggregate function is utilized to create aggregate signatures for each party's signatures and send them to the other party. Upon receipt, the receiving party verifies aggregate signatures and proofs;
one party sends the transaction signature to the other, requesting the transaction to be activated and initiating the asset exchange process. The recipient, based on the signature, constructs an asset transfer transaction and announces its transaction signature. The other party receives the signature and constructs an asset transfer transaction.
upon completion of the transaction, it is broadcast on the blockchain and packed into a block. After a certain period of confirmation, the transaction becomes valid, completing the asset exchange.

According to the second aspect of the present invention, a system is disclosed for facilitating secure and convenient atomic swaps of assets between different blockchains, thereby eliminating the need for funds to be held in escrow, in which the system comprises:
a module for participants to negotiate and determine the terms and conditions of two transactions;
a module for participants to use their private keys to sign the transaction content on different blockchains;
a module for generating aggregate signatures and proofs that uses a reversible aggregate signature function to produce transaction signatures. In addition, it generates a proof of the relationship between the aggregate signature and the two transaction contents and sends this information to the other party. The recipient will carry out verification, and if validation fails, the swap process is immediately terminated.
a module for submitting the transaction, where either party sends a transaction signature to the other, requesting the transaction to become effective. The recipient constructs an asset transfer transaction based on the signature and publishes its transaction signature. The sender receives the signature and constructs another asset transfer transaction;
a module for transaction verification and recording into the blockchain. Valid transactions are broadcast on blockchains and packed into blocks. After a certain period of confirmation, the transaction becomes valid, completing the asset exchange.

### BRIEF DESCRIPTION OF THE DRAWINGS

Embodiments of the invention are described hereinafter in detail with reference to the drawings, in which:

FIG. 1 displays the system thumbnail, as illustrated in this embodiment of the invention;

FIG. 2 is a schematic diagram of the transaction;

FIG. 3 is the data for transaction verification, where the input may come from different source.

### DETAILED DESCRIPTION OF THE EMBODIMENTS

The following discloses an embodiment of the invention, aiming to achieve escrow-free, secure, and convenient atomic cross-chain asset swaps.

Traditional asset exchanges between different blockchains usually require the locking of transaction assets to ensure participants exchange according to the agreement and to prevent fraudulent actions. However, this approach may lead to inefficiencies, poor liquidity, and limited scalability. The escrow-free atomic cross-chain swap method disclosed by this invention offers a faster and more convenient way of swapping assets, enhancing liquidity and reducing the influence of external factors on the swap. Moreover, by embedding the recipient's confirmation within the transaction, it effectively minimizes human errors, deters fraudulent actions, and boosts the security of the transaction.

In blockchain structures that adopt the UTXO model, such as Bitcoin, the receiving address is often based on the hash value of a public key. When a user sets up a wallet, the system generates a pair of public and private keys. This public key is processed through a specific hash function to produce a hash value. This hash value is then encoded (e.g., using Base58Check encoding) to form the user's Bitcoin receiving address. There are reasons for choosing the hash value of the public key as the address: Firstly, the public key remains undisclosed until the funds are actually used, enhancing privacy; secondly, the length of the hash value is shorter than the entire public key, which helps optimize storage and efficiency.

Assume σₓ and σ_{y} are signatures generated for messages x and y, respectively, using a signing scheme that possesses deterministic, homomorphic, and unforgeable properties. Function F (σₓ, σ_{y}) is a reversible signature aggregate function, and F (σₓ, σ_{y}) exhibits the following properties:

### 1. Unforgeable

for any pair of messages (x′, y′)≠(x, y) generated by an adversary, the probability of is negligible.

### 2. Reversible

there is a function G(⋅), such that \tilde{σ}ₓ=G(F(σₓ,σ_{y}),σ_{y}′) for any signature σ_{y}′ on message y, where \tilde{σ}ₓ is signature of message x. Similarly for message y.

Let's assume User1 and User2 are any two users in the system. User1 has wallet W₁₁ on blockchain A and wallet W₁₂ on blockchain B. User2 has wallet W₂₁ on blockchain A and wallet W₂₂ on blockchain B. In W₁₁, User1 holds α coins, and in W₂₂, user2 holds β coins. To exchange assets, they construct transactions TX₁ and TX₂, respectively. Through TX₁, User1 transfers a coins to User2's wallet W₂₁ on blockchain A. Meanwhile, User2 sends β coins to user1's wallet W₁₂ on blockchain B through TX₂.

Our primary objective is to ensure the atomicity of cross-chain asset swaps, meaning that once an exchange is initiated, it either completes successfully or fails entirely, with no in-between states allowed. Secondly, we aim to achieve an escrow-free fund exchange. Traditional atomic exchange protocols often rely on trusted third parties, smart contracts, or shared addresses to lock, unlock, or rollback funds, but we seek to move away from these dependencies, aiming for greater decentralization. Lastly, we strive to simplify the operational process of atomic swaps and reduce the associated costs. Many current exchange mechanisms, such as hash-time-locked contracts or shared addresses, require specific script support and can be affected by time differences between blockchains. Specifically, using shared addresses might lead to complex key management issues and potential privacy breaches, posing additional challenges in technical implementation and management.

To meet all three objectives of the embodiments, the recipient's confirmation of the transaction contents into the transaction itself. This means that each transaction not only requires the sender's signature but also the recipient's confirmation signature. In this implementation, we use a reversible signature aggregation function to produce an aggregated signature for the transaction participants. Moreover, optional proof is generated for participants, evidencing the relationship between the aggregated signature and the transaction contents. Participants exchange proofs off-chain. As soon as one party discloses its signature, the other can initiate its transfer transaction and also reveal its transaction signature. With this signature in hand, the initiator can then construct and broadcast the corresponding transfer transaction.

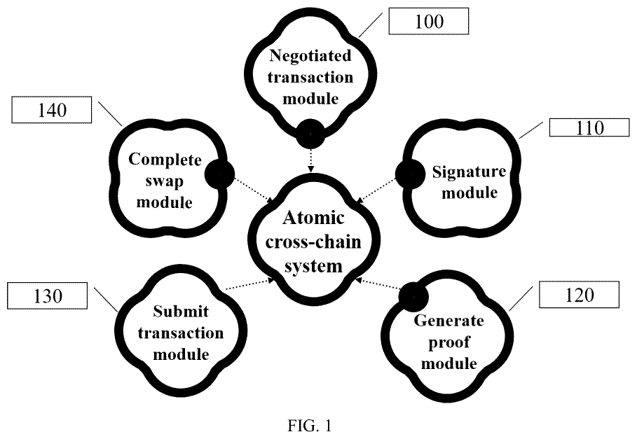

The following embodiments will be described in detail with reference to FIGS. 1-FIG. 3. FIG. 1 illustrates an atomic cross-chain asset swap system where these embodiments can be implemented. The atomic cross-chain asset swap system includes a negotiation transaction module 100, a signature module 110 characterized by determinism, homomorphism, and non-repudiation, a proof generation module 120 featuring a reversible signature aggregation function, a transaction submission module 130, and a swap completion module 140.

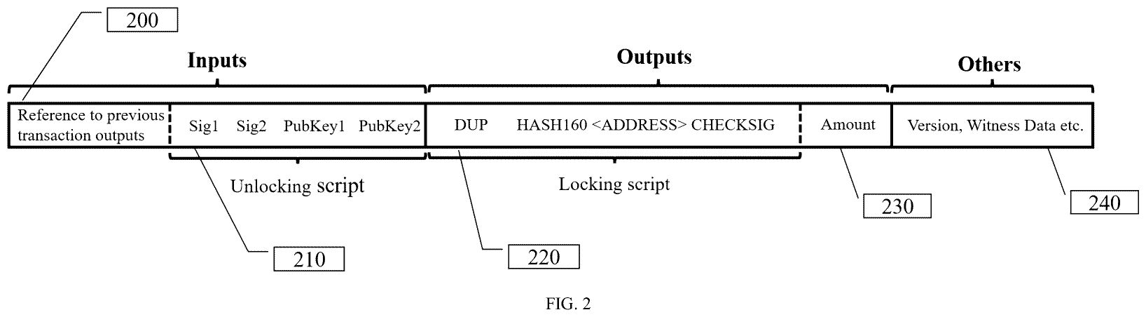

FIG. 2 illustrates a schematic diagram of the transaction constructed in the escrow-free atomic cross-chain swap as per the embodiment of this invention. Blockchain transactions based on the UTXO model can mainly be divided into three parts: input, output, and others 240. The input consists of a reference to previous transaction outputs 200 and unlocking script 210. The reference to previous transaction output 200 represents a reference to the unspent output in the transaction. The unlocking script 210 includes the sender's digital signature, the recipient's confirmation signature, and the sender's public key. The output section is composed of the locking script 220 and the amount 230. The locking script 220 sets the conditions that must be met to use the output, while the amount 230 indicates the funds available for use in subsequent transactions after this transaction is completed. Other 240 may include the transaction hash, transaction version number, and further details.

When a node in the blockchain network receives a transaction TX, it will verify it through the following steps:
1. Check if HASH (PubKey1) matches [symbol] ADDRESS [symbol] . HASH(x) is a one-way function, ensuring that the address derived from the public key matches the receiving address specified in the referenced transaction.
2. CHECKSIG(Sig1,PubKey1,m) is to check whether Sig1 is a signature of message m against a public key PubKey1. Here, m includes the locking script of the previous transaction and some information from the current transaction.
3. CHECKSIG(Sig2,PubKey2,m) is to check whether Sig2 is a signature of message m against a public key PubKey2. In this case, Sig2 represents the confirmation of the transaction information m by the transaction recipient.

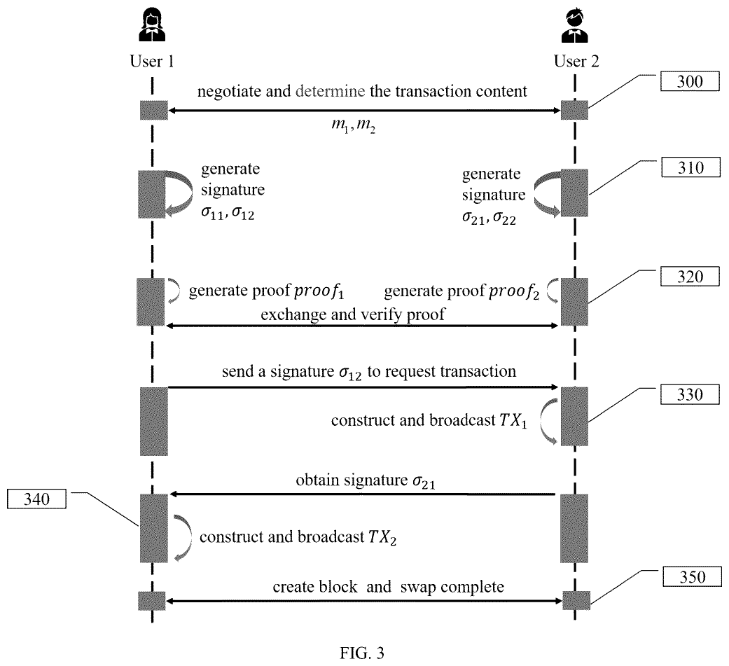

FIG. 3 presents a flowchart of the escrow-free atomic cross-chain asset swap based on the embodiment of this invention. In step 300, User1 and User2 negotiate and determine two transaction contents m₁ and m₂. Specifically, m₁ entails User1 transferring α units of coin to user2's wallet address on blockchain A, with certain specific conditions (such as signatures from both parties) required to validate the transaction; similarly, m₂ involves User2 transferring β units of coin to User1's wallet address on blockchain B, also subject to certain conditions.

In step 310, User1 uses his private key sky from blockchain A and sk₁₂ from blockchain B to sign the messages m₁ and m₂, generating signatures σ₁₁ and σ₁₂. Meanwhile, User2 also signs the messages m₁ and m₂, generating signatures σ₂₁ and σ₂₂.

After signature generation, User1 employs the reversible signature aggregation function F (x, y) in step 320 to aggregate σ₁₁ and σ₁₂,

C₁=F(σ₁₁,σ₁₂).

Moreover, User1 generates an optional proof proof₁ for User2, demonstrating the relation between C₁, m₁, and m₂. User1 sends the message (C₁, proof₁) to User2 through an off-chain channel. Upon receipt of the message, User2 initiates its verification with the major data shown in FIG. 3; If the verification fails, the exchange procedure is discontinued. Concurrently, User2 utilizes the identical process to generate message (C₂, proof₂) and forwards it to User1. On receipt of the message, User1 also undertakes its verification. Any proof that does not pass verification will lead to the immediate cessation of the exchange process.

Next, if either party plans to initiate a transaction, they must send the transaction signature to the other party. Taking User1 in step 330 as an example, User1 will send σ₁₂ to User2. Upon receipt of σ₁₂, User2 can recover σ₁₁ based on C₁ and σ₁₂. At this juncture, User2 has the capability to construct TX₁, as illustrated in FIG. 2, succinctly represented as TX₁= [symbol] σ₁₁,σ₂₁,m [symbol] . Next, TX₁ is broadcast on blockchain A. In step 340, User1, by monitoring the network communication of blockchain A, obtains the signature σ₂₁ and uses the reversibility of function F (⋅,⋅) to restore σ₂₂. User1 can then construct TX₂= [symbol] σ₁₂,σ₂₂,m₂ [symbol] . In step 330, if User2 decides to abort the exchange, σ₂₁ will not be disclosed, resulting in no exchange taking place, ensuring neither party incurs any loss. However, once TX₁ is broadcast, User1 is compelled to construct TX₂, otherwise User1 will incur a double loss.

In step 350, the valid transactions TX₁ and TX₂ are respectively packaged into the corresponding blocks of blockchains A and B. Once the block is confirmed, the transfer operation will take effect, thereby completing the exchange.

What is claimed is:

1. A method for asset swapping between blockchains supporting recipient's confirmation in a transaction, comprising:
negotiating to determine content of asset swapping transactions;
producing individual signatures on the transaction content by each participant;
creating aggregate signatures from the individual signatures by each participant;
exchanging the aggregate signatures between the participants;
verifying the aggregate signatures; if negative, quit;
constructing a first transaction by a second participant;
broadcasting the first transaction by the second participant;
constructing a second transaction by a first participant;
broadcasting the second transaction by the first participant;
validating the broadcast transactions by blockchain node or miners.

2. The method according to claim 1, wherein the step that participants negotiate and determine the transaction contents comprise a locking script of the referenced previous transaction, transaction amounts, a flag indicating whether a recipient's signature is comprised in the transaction.

3. The method according to claim 1, wherein the participants sign the transaction contents according to a signature scheme comprising Boneh-Lynn-Shacham (BLS) or Schnorr signature scheme.

4. The method according to claim 1, wherein the aggregate signature is generated using a reversible signature aggregate function to secure against forgery.

5. The method according to claim 4, wherein the reversible signature aggregate function is constructed with a BLS signature scheme given that public keys are authenticated.

6. The method according to claim 4, wherein the reversible signature aggregate function is constructed with a Schnorr signature scheme given that public keys are authenticated, and each ephemeral public key for signing a transaction content is fixed in a swap process.

7. The method according to claim 1, wherein a swap process quits if the verification of the aggregate signature is negative.

8. The method according to claim 1, wherein the operation of constructing the first transaction comprises
means for a first party to send an individual signature on the transaction content to a second party; if the individual signature is for payment, a signature aggregation of the first party is allowed to be optional;
means for the second party to recover all the individual signatures of the first party;
means for the second party to construct a transaction comprising the transaction content in favor of the second party and its individual signatures from all the parties.

9. The method according to claim 1, wherein the operation of constructing the second transaction comprises:
means for a first party to verify the first transaction; if a verification result is negative, the swap process is terminated;
means for the first party to recover all the individual signatures of a second party;
means for the first party to construct a transaction comprising the transaction content in favor of the first party and its individual signatures from all the parties.

10. The method according to claim 1, wherein the operation of validating the transaction comprises:
upon receiving the transaction, wherein the blockchain miners check a format of the transaction according to a blockchain specification;
verifying, by the miners, the signature from a transaction payer; if a verification result is negative, the transaction is rejected;
verifying, by the miners, the signature from a transaction payee if a flag is set; if a verification result is negative, the transaction is rejected;
packing, by the miners, the accepted transaction into a block and broadcasting the block to a blockchain network.

11. A system for facilitating asset swapping between blockchains, comprising:
a module for participants to negotiate and determine the transaction content;
a module for participants to use their private keys to sign the transaction content on blockchains to provide individual signatures;
a module for generating aggregate signatures from the individual signatures;
a module for carrying out verification on the aggregate signature;
a module for constructing a first transaction;
a module for broadcasting the first transaction on the blockchain;
a module for constructing a second transaction;
a module for broadcasting the second transaction on the blockchain;
a module for validating the transactions.

12. The system according to claim 11, wherein the negotiation on the transaction contents is off-chain.

13. The system according to claim 11, wherein the transaction content comprise information related to a locking script of a referenced previous transaction, a transaction amount, a flag indicating whether a recipient's signature is comprised in the transaction, and other relevant information.

14. The system according to claim 11, wherein the individual signature is produced with a homomorphic signature scheme, wherein an output is either immutable due to some restrictions or deterministic.

15. The system according to claim 11, wherein the aggregate signature is produced from the individual signatures from the same signer using a reversible signature aggregate function.

16. The system according to claim 15, wherein the reversible signature aggregate function is secure against signature forgery, wherein the reversible signature aggregate function is constructed from BLS or half-aggregated Schnorr signature scheme.

17. The system according to claim 11, wherein if an aggregate signature verification fails, the transaction is rejected.

18. The system according to claim 11, wherein the operation of constructing the first transaction comprises:
sending, by a first party, an individual signature on the transaction content to a second party; if the individual signature is for payment, a signature aggregation of the first party is allowed to be optional;
recovering, by the second party, all the individual signatures of the first party;
constructing a transaction comprising the transaction content in favor of the second party and its individual signatures from all the parties.

19. The system according to claim 11, wherein the operation of constructing the second transaction comprises:
verifying, by a first party, the first transaction; if negative, a swap process is terminated;
recovering, by the first party, all the individual signatures of a second party;
constructing a transaction comprising the transaction content in favor of the first party and its individual signature from all the parties.

20. The system according to claim 11, wherein the operation of verifying the transaction comprises:
upon receiving the transaction, wherein the blockchain miners check a format of the transaction according to a blockchain specification;
verifying, by the miners, the signature from a transaction payer; if a verification result is negative, the transaction is rejected;
verifying, by the miners, the signature from a transaction payee if a flag is set; if a verification result is negative, the transaction is rejected;
packing, by the miners, the accepted transaction into a block, and broadcasting the block to a blockchain network.
